(19) United States
(12) Patent Application Publication
(10) Pub. No.: US 2023/0242210 A1
(43) Pub. Date: Aug. 3, 2023

(54) BICYCLE CHAIN RING

(71) Applicant: Phillip Earnest Maxwell, Rancho Cucamonga, CA (US)

(72) Inventor: Phillip Earnest Maxwell, Rancho Cucamonga, CA (US)

(21) Appl. No.: 18/096,278

(22) Filed: Jan. 12, 2023

Related U.S. Application Data
(60) Provisional application No. 63/306,119, filed on Feb. 3, 2022.

(51) Int. Cl. B62M 9/02; B62M 1/36; F16H 55/30

(52) U.S. Cl. CPC B62M 9/02; B62M 1/36; F16H 55/30

(57) ABSTRACT

A bicycle chain ring has a ring body having an inner diameter edge and an outer diameter edge. The outer diameter edge has a plurality of teeth for engaging a bicycle chain. The chain ring further includes a shared bolt hole through the ring body; a first set of three bolt holes through the ring body that are positioned in circumferentially spaced positions so that the shared bolt hole and the three bolt holes of the first set align to mate with the 4-bolt bicycle crank; and a second set of four bolt holes through the ring body that are positioned in circumferentially spaced positions so that the shared bolt hole and the four bolt holes of the second set align to mate with the 5-bolt bicycle crank.

### BACKGROUND OF THE INVENTION

### Field of the Invention

This invention relates generally to bicycle chain rings, and more particularly to a bicycle chain ring that may be used with either a 4-bolt or a 5-bolt bicycle crank.

### Description of Related Art

Bicycle chain rings are typically adapted for use with a single type of bicycle crank. Since there are many types of bicycle cranks, this requires that a large number of bicycle chain rings also be carried by retailers; and furthermore, if a bicyclist decides to change his or her bicycle crank, he or she must also change his or her bicycle chain ring.

The prior art does not teach a bicycle chain ring that may be used with either a 4-bolt or a 5-bolt bicycle crank. The present invention fulfills these needs and provides further advantages as described in the following summary.

### SUMMARY OF THE INVENTION

The present invention teaches certain benefits in construction and use which give rise to the objectives described below.

The present invention provides a bicycle chain ring that may be used with either a 4-bolt bicycle crank or a 5-bolt bicycle crank. The bicycle chain ring includes a ring body having an inner diameter edge and an outer diameter edge, the outer diameter edge having a plurality of teeth. The chain ring further includes a shared bolt hole through the ring body; a first set of three bolt holes through the ring body that are positioned in circumferentially spaced positions so that the shared bolt hole and the three bolt holes of the first set align to mate with the 4-bolt bicycle crank; and a second set of four bolt holes through the ring body that are positioned in circumferentially spaced positions so that the shared bolt hole and the four bolt holes of the second set align to mate with the 5-bolt bicycle crank.

A primary objective of the present invention is to provide a bicycle chain ring having advantages not taught by the prior art.

Another objective is to provide a bicycle chain ring that may be used with either a 4-bolt bicycle crank or a 5-bolt bicycle crank.

A further objective is to provide a bicycle chain ring that enables manufacturers and retailers to carry less inventory, and to enable users to transition between a 4-bolt bicycle crank and a 5-bolt bicycle crank without having to replace their bicycle chain ring.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention.

FIG. 1 is a side elevation view of a bicycle chain ring according to one embodiment of the present invention.

FIG. 2 is a side elevation view of the bicycle chain ring of FIG. 1 being used in conjunction with a 4-bolt bicycle crank.

FIG. 3 is a side elevation view of the bicycle chain ring of FIG. 1 being used in conjunction with a 5-bolt bicycle crank.

FIG. 4 is a side elevation view of another embodiment of a bicycle chain ring of the present invention.

### DETAILED DESCRIPTION OF THE INVENTION

The above-described drawing figures illustrate the invention, a bicycle chain ring that is adapted to be used with either a 4-bolt bicycle crank or a 5-bolt bicycle crank. By enabling use of a single bicycle chain ring with multiple cranks, it is possible for manufacturers and retailers to carry far less inventory, and it also enables a bicyclist to keep his or her bicycle chain ring even if he or she changes bicycle cranks.

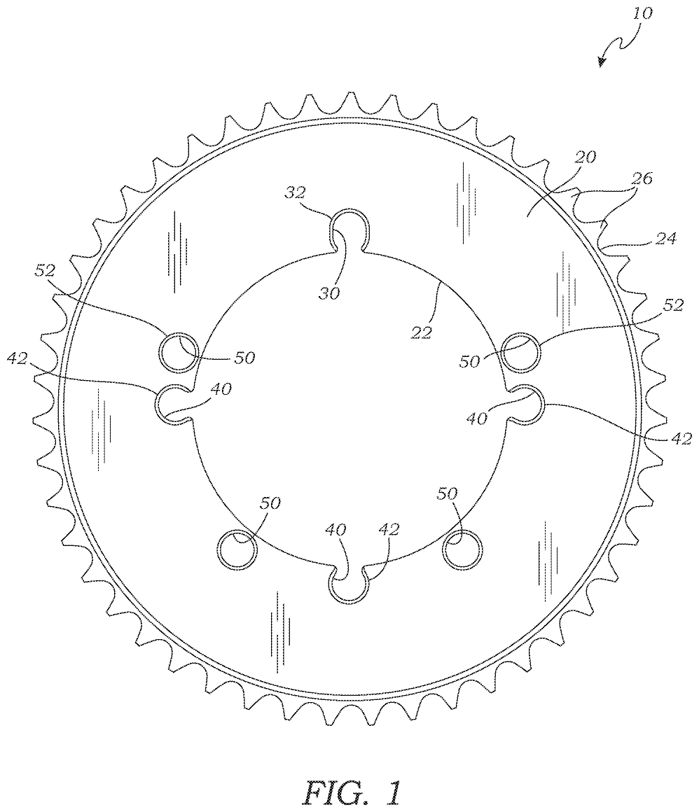

FIG. 1 is a side elevation view of a bicycle chain ring 10 according to one embodiment of the present invention. As shown in FIG. 1, the bicycle chain ring 10 includes a ring body 20 having an inner diameter edge 22 and an outer diameter edge 24. The outer diameter edge 24 has a plurality of teeth 26 that are adapted to engage a chain of a bicycle, as is well known in the art.

The bicycle chain ring 10 includes a plurality of holes in a unique pattern, as discussed below, so that they are adapted to allow the mounting of different types of bicycle cranks onto the bicycle chain ring 10. In this embodiment, the pattern of plurality of holes includes a shared bolt hole 30, a first set of three bolt holes 40, and a second sets of four bolt holes 50, which are discussed in greater detail below.

Critical to the present invention is the shared bolt hole 30 through the ring body 20. The shared bolt hole 30 may be positioned near or adjacent to the inner diameter edge 22, and may even (as illustrated) connect with and form an integral part of the inner diameter edge 22; however, in other embodiments, it might be separated (as shown with other holes).

The shared bolt hole 30 preferably has a larger diameter than a diameter of the first and second sets of bolt holes 40 and 50. In this embodiment, the shared bolt hole 30 has a slightly larger diameter. For purposes of this application, the term “slightly larger” is defined to mean 5-20% larger in diameter.

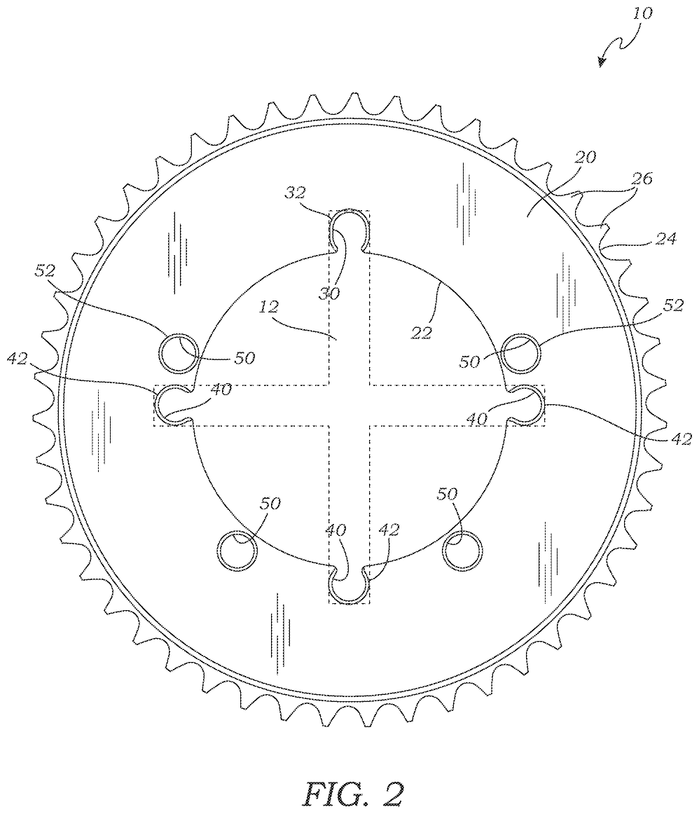

FIG. 2 is a side elevation view of the bicycle chain ring 10 of FIG. 1 being used in conjunction with a 4-bolt bicycle crank 12. As shown in FIGS. 1 and 2, the first set of three bolt holes 40 through the ring body 20 are positioned in circumferentially spaced positions of equal diameter so that the shared bolt hole 30 and the three bolt holes of the first set 40 align to mate with the 4-bolt bicycle crank 12.

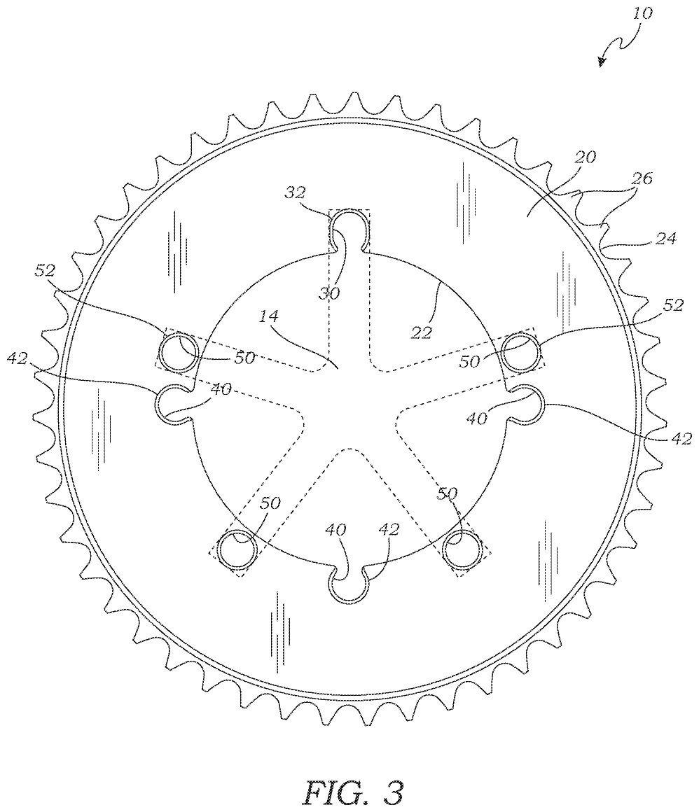

FIG. 3 is a side elevation view of the bicycle chain ring 10 of FIG. 1 being used in conjunction with a 5-bolt bicycle crank 14. As shown in FIGS. 1 and 3, the second set of four bolt holes 50 through the ring body 20 that are positioned in circumferentially spaced positions of equal diameter so that the shared bolt hole 30 and the four bolt holes of the second set 50 align to mate with the 5-bolt bicycle crank 14.

As shown in FIG. 1, in this embodiment the shared bolt hole 30 includes a recessed rim 32. Similarly, in this embodiment the first set of three bolt holes 40 each include a recessed rim 42, and the second set of four bolt holes 50 each include a recessed rim 52.

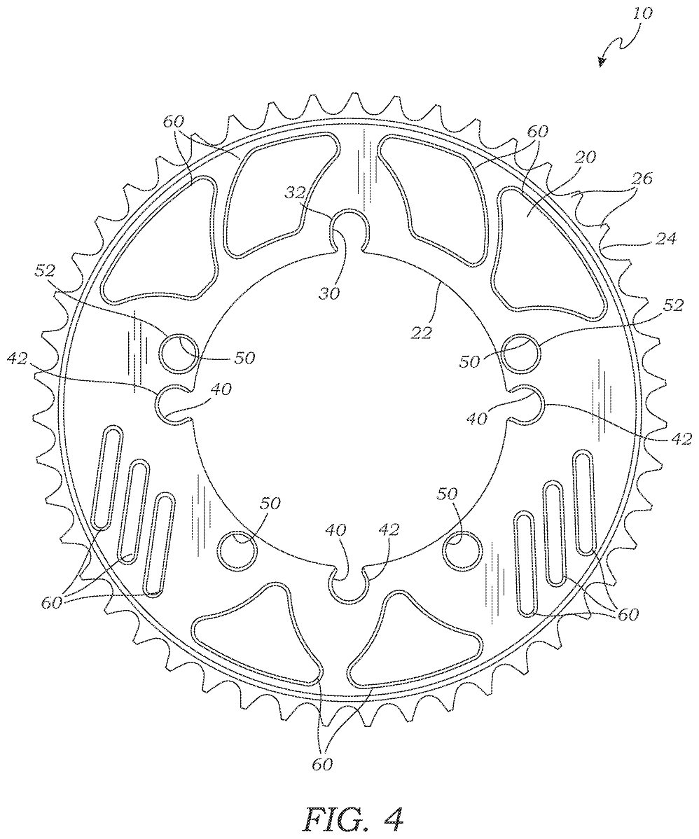

FIG. 4 is a side elevation view of another embodiment of a bicycle chain ring 10 of the present invention. In the embodiment of FIG. 4, the ring body 20 further includes a plurality of cut-outs 60 that are positioned around and/or between the first and second sets of bolt holes 40 and 50.

The title of the present application, and the claims presented, do not limit what may be claimed in the future, based upon and supported by the present application. Furthermore, any features shown in any of the drawings may be combined with any features from any other drawings to form an invention which may be claimed.

As used in this application, the words “a,” “an,” and “one” are defined to include one or more of the referenced item unless specifically stated otherwise. The terms “approximately” and “about” are defined to mean+/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

What is claimed is:

1. A bicycle chain ring that may be used with either a 4-bolt bicycle crank or a 5-bolt bicycle crank, the bicycle chain ring comprising:
a ring body having an inner diameter edge and an outer diameter edge, the outer diameter edge having a plurality of teeth;
a shared bolt hole through the ring body;
a first set of three bolt holes through the ring body that are positioned in circumferentially spaced positions so that the shared bolt hole and the three bolt holes of the first set align to mate with the 4-bolt bicycle crank; and
a second set of four bolt holes through the ring body that are positioned in circumferentially spaced positions so that the shared bolt hole and the four bolt holes of the second set align to mate with the 5-bolt bicycle crank.

2. The bicycle chain ring of claim 1 wherein the share bolt hole has a slightly larger diameter than a diameter of the first and second sets of bolt holes.

3. The bicycle chain ring of claim 1 wherein the ring body further includes a plurality of cut-outs that are positioned around the first and second sets of bolt holes.
